(19) United States
(12) Patent Application Publication
(10) Pub. No.: US 2009/0126637 A1
(43) Pub. Date: May 21, 2009

(54) DEVICE INCLUDING A MILK-CONVEYING TUBULAR MEMBER

(75) Inventor: Helmut Obermuller, Stockholm (SE)

Correspondence Address: HOVEY WILLIAMS LLP, 10801 Mastin Blvd., Suite 1000, Overland Park, KS, 66210, US

(73) Assignee: DeLaval Holding AB, Tumba (SE)

(21) Appl. No.: 12/278,746

(22) PCT Filed: Feb. 5, 2007
(86) PCT No.: PCT/SE2007/050067

§ 371 Date: Oct. 3, 2008

(30) Foreign Application Priority Data
Feb. 17, 2006 (SE) 0600354-5

(51) Int. Cl. A01J 5/007; A01J 5/01

(52) U.S. Cl. 119/14.08; 119/14.51

(57) ABSTRACT

The invention refers to a device including a milk-conveying tubular member (1) of an elastic material. The tubular member is adapted 5 to convey a flow of milk and includes a wall (6) having an outer surface (6a) and an inner surface (6b) facing an inner space (7) of the tubular member. A first electrode member (11) is provided in the wall and has a first contact surface (13) facing the inner space and provided to contact the milk flowing the tubular member. The first 10 electrode member is formed by an electrically conducting polymer.

### BACKGROUND OF THE INVENTION AND PRIOR ART

The present invention refers to a device including

a milk-conveying tubular member of an elastic material, the tubular member being adapted to convey a flow of milk and including a wall with an outer surface and an inner surface facing an inner space of the tubular member, and
at least a first electrode member provided in the wall and having a first contact surface facing the inner space and provided to contact the milk flowing in the tubular member.

It is known to provide an electrode member in such a milk-conveying tubular member, for instance a teatcup liner, in order to measure an electrical parameter of the milk. An example of such an electrical parameter is the electrical conductivity of the milk. The value of the electrical conductivity depends on the concentration of ions and micro-organisms in the milk. The value of the electrical conductivity can thus be used to determine whether the milk is infected by for instance mastitis.

EP-A-1360894 discloses a teatcup having three sensors mounted in different positions in the teatcup. One of the sensors appears to be provided in the teatcup liner proper. This sensor is intended to permit measurement of the conductivity of the milk.

EP-A-677243 discloses a milking plant for automatic milking, so-called quarter milking. Each milk conduit includes a milk flow sensor provided for sensing the milk flow from a respective teat. Neither the design nor the position of the sensors are not disclosed.

EP-A-1279326 discloses a milking plant for quarter milking, including four teatcups and four milk conduits from a respective one of the teatcups. Each milk conduit includes a milk flow meter, a temperature meter and a conductivity meter. The milk flow meter may be of the kind including two electrodes.

### SUMMARY OF THE INVENTION

The object of the present invention is to provide a device designed to permit conveying of milk and including an electrode enabling measurements on the milk. A further object is to provide such a device which may be manufactured in an easy and cost-efficient manner.

This object is achieved by the device initially defined, which is characterised in that the first electrode member is formed by an electrically conducting polymer. Such an electrode member can be moulded into the elastic material of the wall to form an integrated part of the tubular member. The manufacturing of the device according to this invention may thus be performed in an easy and cost-efficient manner in a moulding process resulting in a strong bonding between the elastic material and the electrically conducting polymer. Such an electrically conducting polymer ensures a reliable electrode function throughout the life of the milk-conveying tubular member.

According to an embodiment of the invention, the first electrode member is embedded in the elastic material of the wall. The electrode member thus forms an integrated part of the tubular member. Furthermore, the first contact surface may coincide with a surrounding surface of the inner surface. Consequently, no protruding portions need to project into the inner space of the tubular member.

According to a further embodiment of the invention, the first electrode member has an annular shape extending around the inner surface of the tubular member. With such an electrode member in the form of a ring, the electrode may operate in a proper way. The probability that at least a part of the annular electrode member, i.e. the annular contact surface of the electrode member, is in contact with the milk flowing in the inner space is very high.

According to a further embodiment of the invention, the tubular member has a second electrode member having a second contact surface provided to contact the milk flowing in the tubular member, wherein the second electrode member is provided at a distance from the first electrode member. By arranging two electrode members in such a way, for instance the electrical conductivity of the milk may be measured. Advantageously, the second electrode member is provided in the wall, wherein the second contact surface faces the inner space. Furthermore, also the second electrode member may be formed by an electrically conducting polymer. Also the second electrode member may be embedded in the elastic material of the wall, wherein the second contact surface may coincide with a surrounding surface of the inner surface. Advantageously, also the second electrode member may have an annular shape extending around the inner surface of the tubular member. The electrically conducting polymer may have an elasticity which is substantially equal to the elasticity of the elastic material. In such a way, the flexibility and elastic properties of the tubular member will not be negatively influenced by the provision of one, two or more electrode members.

According to a further embodiment of the invention, the elastic material is electrically non-conducting.

According to a further embodiment of the invention, the elastic material and the electrically conducting polymer are fused with each other. In such a way a strong bonding between the elastic material and the electrically conducting polymer is achieved so that the first and/or second electrode member will form an integrated part of the tubular member.

According to a further embodiment of the invention, the tubular member forms a teatcup liner. It is advantageous to be able to provide such an electrode member directly in the teatcup liner permitting measurements on the milk immediately after the milk has been extracted from the teat of the animal. The teatcup liner includes a teat-receiving part and a milk-conveying part, wherein the first electrode member may be provided downstream the teat-receiving part in the milk-conveying part. The milk-conveying part starts immediately downstream the teat introduced into the inner space of the teatcup liner. Furthermore, the second electrode member may be provided in the milk-conveying part downstream the first electrode member.

According to a further embodiment of the invention, the device includes a processing unit to which the first electrode member is connected. Advantageously, also the second electrode member is connected to the processing unit. The processing unit may be responsive to the value of an electrical parameter sensed by the first electrode member and the second electrode member. The electrical parameter may for instance be the electrical conductivity of the milk. The value of the electrical conductivity may be used to determine if a milk flow exists. In such a way, the device according to the invention provides a simple detector for deciding whether a milk flow exists or not. Such a detector can be used for determining when the milking is to be interrupted, i.e. when the milking vacuum is to be disconnected from the inner space of the tubular member. The value of the electrical conductivity may also be used to determine whether the milk is infected, e.g. by mastitis. The processing unit may also be adapted to use the value of the electrical parameter to determine the size of the milk flow.

### BRIEF DESCRIPTION OF THE DRAWINGS

The present invention is now to explained more closely by means of the following description of preferred embodiments and with reference to the drawings attached hereto.

FIG. 1 discloses a first embodiment of a device according to the invention.

FIG. 2 discloses a second embodiment of a device according to the invention.

FIG. 3 discloses a third embodiment of a device according to the invention.

### DETAILED DESCRIPTION OF VARIOUS EMBODIMENTS OF THE INVENTION

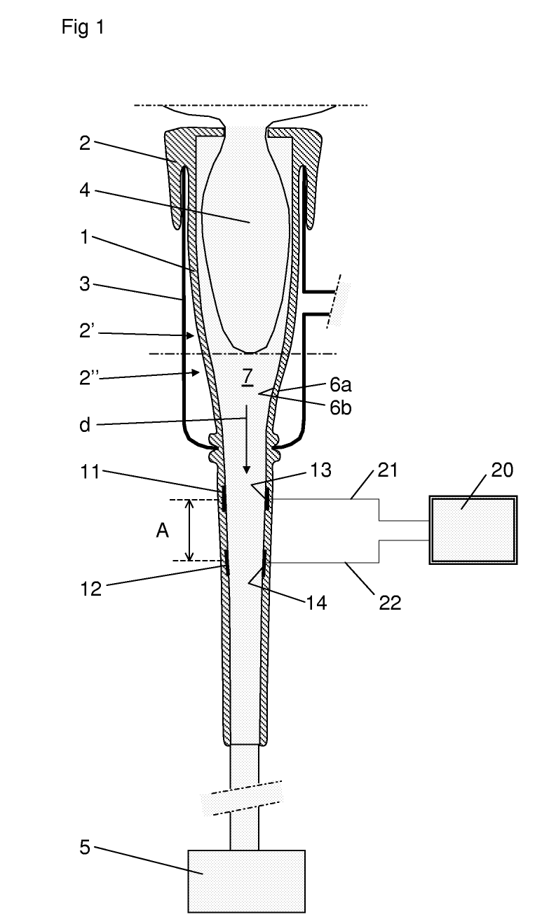

FIG. 1 discloses a device including a milk-conveying tubular member 1 of an elastic material. In the first embodiment, the tubular member 1 includes a teatcup liner 2 to be introduced into a teatcup shell 3 for forming a teatcup to be attached to a teat 4 of an animal to be milked. The tubular member 1 is adapted to convey a flow of milk from the teat 4 in a flow direction d to a schematically indicated milk-receiving member 5.

The tubular member 1 includes a tubular wall 6 having an outer surface 6a and inner surface 6b facing an inner space 7 of the tubular member 1.

The teatcup liner 2 includes a teat-receiving part 2′ for receiving the teat 4 of the animal, and a milk-conveying part 2″ for conveying the milk from the teat 4 to the milk-receiving member 5.

The device also includes a first electrode member 11 and a second electrode member 12. The first electrode member 11 and the second electrode member 12 are both provided in the wall 6 of the tubular member 1 in the embodiments disclosed.

The first electrode member 11 has a first contact surface 13 facing the inner space 7 and provided to contact the milk flowing in the tubular member 1. The second electrode member 12 has a second contact surface 14 provided to contact the milk flowing in the tubular member 1. As can be seen in FIG. 1, the second electrode member 12 is provided downstream and at a distance A from the first electrode member 11, and thus the electrode members 11 and 12 are separated from each other by the elastic material of the tubular member 12.

In the first embodiment disclosed in FIG. 1, the milk-conveying part 2″ of the teatcup liner 2 includes a short milk conduit extending from the teatcup shell 3 and forming an integrated part of the teatcup liner 2. In the first embodiment, both the first electrode member 11 and the second electrode member 12 are provided downstream the teat-receiving part 2′ in the milk-conveying part 2″, and more precisely in the short milk conduit beneath the teatcup shell 3.

The first electrode member 11 and the second electrode member 12 are formed by an electrically conducting polymer. The first electrode member 11 and the second electrode member 12 are embedded in the elastic material of the wall 6 in such a way that the contact surfaces 13 and 14 coincide with a surrounding surface of the inner surface 6b, and that the electrodes 11 and 12 are electrically isolated from each other by the elastic material of the wall 6. Furthermore, both the first electrode member 11 and the second electrode member 12 have an annular shape extending around the inner surface 6b of the tubular member 1.

The electrically conducting polymer 11 of the electrode members 11, 12 is fused with the elastic material of the wall 6 of the tubular member 1. By selecting a suitable elastic material for the wall 6 and a suitable polymer for the electrode members 11, 12, a strong bonding between the electrode members 11, 12 and the wall 6 may be achieved. Suitable examples of the elastic material are natural and synthetic rubber, for instance silicon rubber, and polymer materials such as Thermo Plastic Elastomers, TPE, for instance polyolefin, polypropylene polyamid. Suitable examples of the electrically conducting polymer are electrically conducting Thermoplastic Elastomers, TPE, for instance polypropen. Preferably, the elastic material of the wall 6 is electrically non-conducting. It is also advantageous if the elasticity of the electrically conducting polymer is approximately equal to or at least in the same order as the elasticity of the elastic material.

In the embodiments disclosed, the electrode members 11, 12 having the annular shape as mentioned above, may be prefabricated as rings of a suitable dimension. These rings may be positioned in a mould into which the elastic material is then injected at a suitable temperature and a suitable pressure. In such a way the tubular member 1 can be manufactured in an easy and cost-efficient manner.

The device also includes a processing unit 20 to which the first electrode member 11 and the second electrode member 12 are connected via a respective electric conductor 21, 22. The electric conductors 21, 22 may be of any suitable kind, e.g. a metal wire extending through the elastic material of the wall into the electrically conducting polymer. By means of the processing unit 20 and the electrode members 11, 12, various parameters of the milk flowing in the inner space 7 can thus be measured. For instance, the electrode members 11, 12 may be employed for measuring the electrical conductivity of the milk. According to a first example, such conductivity measurement can be used to determine whether there is a milk flow or not. In such a way the processing unit 20 and the electrode members 11, 12 may form a detector for deciding whether the milking operation is to be interrupted or not. According to a second example, the electrode members 11, 12 and the processing unit 20 may be used to determine a value of the electrical conductivity of the milk. This value can be employed for determining whether the milk is infected, e.g. by mastitis.

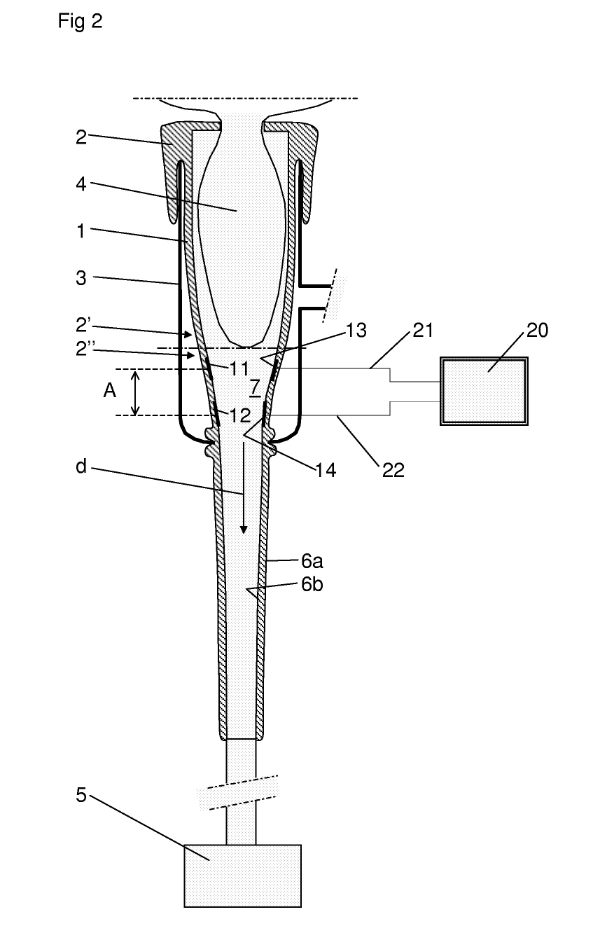

The second embodiment disclosed in FIG. 2 differs from the first embodiment in that the electrode members 11, 12 are provided in the teatcup liner 2 above the short milk conduit. However, as can be seen from FIG. 2, the electrode members 11, 12 are still provided in the milk-conveying part 2″ downstream the teat-receiving part 2′. Consequently, the electrode members 11, 12 are provided downstream the teat where the milk flow exists during the milking operation.

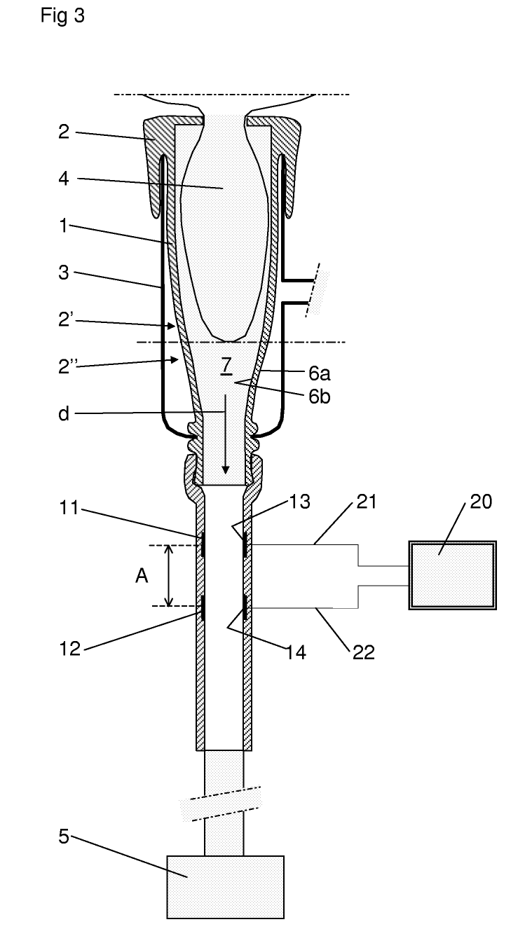

In the third embodiment disclosed in FIG. 3, the electrode members 11, 12 are provided in the short milk conduit of the teatcup liner 2. The third embodiment differs from the previous embodiments in that the short milk conduit of the teatcup liner 2 is provided as a separate part extending from the teatcup shell 3 and the teatcup.

The present invention is not limited to the embodiments disclosed but may be varied and modified within the scope of the following claims. For instance the number of electrode members of the kind described above may vary. The device may include only one such electrode member and a further electrode member of a differing design, which may be positioned downstream the short milk conduit. Furthermore, it is to be noted that the invention is applicable to all kinds of milk-conveying tubular members, also the so-called long milk conduit, for instance.

1. A device including
a milk-conveying tubular member of an elastic material, the tubular member being adapted to convey a flow of milk and including a wall with an outer surface and an inner surface facing an inner space of the tubular member; and
at least a first electrode member provided in the wall and having a first contact surface facing the inner space and provided to contact the milk flowing in the tubular member, wherein the first electrode member is formed by an electrically conducting polymer.

2. A device according to claim 1, wherein the first electrode member is embedded in the elastic material of the wall.

3. A device according to claim 2, wherein the first contact surface coincides with a surrounding surface of the inner surface.

4. A device according to claim 1, wherein the first electrode member has an annular shape extending around the inner surface of the tubular member.

5. A device according to claim 1, wherein the tubular member has a second electrode member having a second contact surface provided to contact the milk flowing in the tubular member, wherein the second electrode member is provided at a distance (A) from the first electrode member.

6. A device according to claim 5, wherein the second electrode member is provided in the wall, wherein the second contact surface faces the inner space.

7. A device according to claim 6, wherein the second electrode member is formed by an electrically conducting polymer.

8. A device according to claim 6, wherein the second electrode member is embedded in the elastic material of the wall.

9. A device according to claim 6, wherein the second contact surface coincides with a surrounding surface of the inner surface.

10. A device according to claim 6, wherein the second electrode member has an annular shape extending around the inner surface of the tubular member.

11. A device according to claim 1, wherein the elastic material is electrically non-conducting.

12. A device according to claim 1, wherein the elastic material and the electrically conducting polymer are fused with each other.

13. A device according to claim 1, wherein the tubular member forms a teatcup liner.

14. A device according to claim 13, wherein the teatcup liner includes a teat-receiving part and a milk-conveying part, and wherein the first electrode member is provided downstream the teat-receiving part in the milk-conveying part.

15. A device according to claim 14, wherein the tubular member has a second electrode member having a second contact surface provided to contact the milk flowing in the tubular member, wherein the second electrode member is provided at a distance from the first electrode member, and wherein the second electrode member is provided in the milk-conveying part downstream the first electrode member.

16. A device according to claim 1, wherein the device includes a processing unit to which the first electrode member is connected.

17. A device according to claim 16, wherein the tubular member has a second electrode member having a second contact surface provided to contact the milk flowing in the tubular member, wherein the second electrode member is provided at a distance from the first electrode member, and also wherein the second electrode member is connected to the processing unit.

18. A device according to claim 17, wherein the processing unit is responsive to the value of an electrical parameter sensed by the first electrode member and the second electrode member.

19. A device according to claim 18, wherein the value of the electrical parameter indicates whether there is a milk flow in the tubular member.

20. A device according to claim 18, wherein the processing unit is adapted to use the value of the electrical parameter to determine the size of the milk flow.
